(19) United States
(12) Patent Application Publication
(10) Pub. No.: US 2011/0268402 A1
(43) Pub. Date: Nov. 3, 2011

(54) SEMICONDUCTOR OPTICAL DEVICE

(75) Inventor: Kazuaki KIYOTA, Tokyo (JP)

(73) Assignee: FURUKAWA ELECTRIC CO., LTD., Tokyo (JP)

(21) Appl. No.: 13/094,312

(22) Filed: Apr. 26, 2011

(30) Foreign Application Priority Data
Apr. 30, 2010 (JP) 2010-105286

(51) Int. Cl. G02B 6/036

(52) U.S. Cl. 385/126

(57) ABSTRACT

A semiconductor optical device includes at least a lower cladding layer formed on a semiconductor substrate, a core layer formed on the lower cladding layer, and an upper cladding layer formed on the core layer. The core layer includes a first core layer of a material susceptible to oxidation and a second core layer of a material unsusceptible to oxidation, the first core layer and the second core layer being connected in sequence in an optical propagation direction. The second core layer is formed at a facet where a light is input or output.

### CROSS-REFERENCE TO RELATED APPLICATION

This application is based upon and claims the benefit of priority from the prior Japanese Patent Application No. 2010-105286, filed on Apr. 30, 2010; the entire contents of which are incorporated herein by reference.

### BACKGROUND OF THE INVENTION

1. Field of the Invention

The present invention relates to a semiconductor optical device used in optical communications and the like.

2. Description of the Related Art

In optical communications systems, semiconductor optical devices are indispensable. Conventionally, in semiconductor light emitting devices as a signal light source and in semiconductor optical modulators in optical communications, GaInAsP grown on an InP substrate is widely used as an active layer material. In recent years, to reduce cost and power consumption, semiconductor optical devices are required to operate at high temperature. Therefore, AlGaInAs on an InP substrate, which has good high temperature characteristics, is used as an active layer material of the semiconductor optical devices.

Because AlGaInAs contains aluminum (Al) as a constituent element, there is a problem in that it is susceptible to oxidation in air. The oxidation of the active layer causes serious consequences in characteristics and reliability of the semiconductor optical device, and thus it is highly undesirable. A buried waveguide structure in which an active layer is formed in a stripe shape and current-blocking semiconductor layers are formed on both sides of the active layer is often used for GaInAsP active layers. However, when AlGaInAs is used as an active layer having such a buried waveguide structure, the oxidation of AlGaInAs is likely to occur in the manufacturing process for processing the active layer. Accordingly, when AlGaInAs is used as the active layer material, a ridge waveguide structure that does not require the processing of the active layer is used.

With the sophistication of optical communications systems, multiple functions often need to be integrated into a semiconductor optical device. In this case, to realize the characteristics required for the elements to be integrated in elements of the integrated device, a plurality of active layers or passive waveguide layers are connected in sequence using a butt-joint method or the like (see, for example, Japanese Patent Application Laid-open No. 2002-324936, and IEEE Journal of Quantum Electronics, Vol. 45, No. 9, p. 1201).

In semiconductor optical devices, input and output facets are generally formed by cleaving. In a semiconductor optical device using an AlGaInAs active layer, the AlGaInAs active layer is exposed at the facets formed by cleaving. Therefore, there is a problem in that AlGaInAs is oxidized near the facet, thereby having adverse effects on the characteristics and the reliability of the semiconductor optical device. To cope with such problem, a technology of suppressing the oxidation of AlGaInAs near the facet by appropriately selecting a coating material applied on the facet formed after cleaving is known (see, for example, Japanese Patent Application Laid-open No. 2005-175111).

### SUMMARY OF THE INVENTION

It is an object of the present invention to at least partially solve the problems in the conventional technology.

According to one aspect of the present invention, there is provided a semiconductor optical device at least a lower cladding layer formed on a semiconductor substrate, a core layer formed on the lower cladding layer, and an upper cladding layer formed on the core layer. The core layer includes a first core layer of a material susceptible to oxidation and a second core layer of a material unsusceptible to oxidation. The first core layer and the second core layer are connected in sequence in an optical propagation direction. The second core layer is formed at a facet where a light is input or output.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a plan view of a semiconductor laser according to a first embodiment of the present invention;

FIG. 2 is a plan view of the semiconductor laser according to the first embodiment without an electrode on an upper surface;

FIG. 3 is a cross-sectional view taken along a line III-III shown in FIG. 1;

FIG. 4 is a cross-sectional view taken along a line IV-IV shown in FIG. 1;

FIG. 5 is a cross-sectional view taken along a line V-V shown in FIG. 1;

FIGS. 6A and 6B are process cross-sectional views illustrating a pattern of a SiNx film in a manufacturing process of the semiconductor laser according to the first embodiment;

FIG. 7 is a process cross-sectional view illustrating a process of etching an active layer in the manufacturing process of the semiconductor laser according to the first embodiment;

FIG. 8 is a process cross-sectional view illustrating a process of burying a core layer in the manufacturing process of the semiconductor laser according to the first embodiment;

FIG. 9 is a process cross-sectional view illustrating a process of growing an upper cladding layer and a contact layer performed following the process of burying the core layer in the manufacturing process of the semiconductor laser according to the first embodiment;

FIG. 10 is a process cross-sectional view illustrating a process of etching a portion between a ridge waveguide and supporting mesas in the manufacturing process of the semiconductor laser according to the first embodiment;

FIG. 11 is a process cross-sectional view illustrating a process of burying a recess between the ridge waveguide and the supporting mesas with planarizing polymer in the manufacturing process of the semiconductor laser according to the first embodiment;

FIG. 12 is a process cross-sectional view illustrating an electrode forming process in the manufacturing process of the semiconductor laser according to the first embodiment;

FIG. 13 is a process cross-sectional view illustrating a cleaving process in the manufacturing process of the semiconductor laser according to the first embodiment;

FIG. 14 is a plan view of an integrated semiconductor laser device according to a second embodiment of the present invention;

FIG. 15 is a cross-sectional view taken along a line XV-XV shown in FIG. 14;

FIG. 16 is a cross-sectional view taken along a line XVI-XVI shown in FIG. 14;

FIG. 17 is a cross-sectional view taken along a line XVII-XVII shown in FIG. 14;

FIG. 18 is a cross-sectional view taken along a line XVIII-XVIII shown in FIG. 14; and

FIG. 19 is a plan view illustrating a mask pattern of stripes wider than laser stripes and a ridge waveguide of a semiconductor optical amplifier excluding vicinities of facets.

### DETAILED DESCRIPTION OF THE PREFERRED EMBODIMENTS

Exemplary embodiments of the present invention will be explained in detail below with reference to accompanying drawings. However, the embodiments should not be construed to limit the present invention, and various modifications of the embodiments are possible without departing from the spirit and scope of the invention. It should be noted that the drawings are schematic and thicknesses of layers and ratios of thicknesses may differ from actual values. Furthermore, some portions may differ in relationship with dimensions and ratios of dimensions from one another among the drawings. Accordingly, the specific dimensions should be determined in consideration of the following explanations.

In the method in which the cleaved facet is coated with a material to suppress the oxidation of AlGaInAs, it is difficult to inhibit the oxidation during a period from cleaving until coating the facet with the material. Furthermore, if the material to coat the facet is restricted, the optical design of the facet coating is limited by that, making it difficult to obtain a desired reflectivity property. Therefore, the method of coating the cleaved facet with the material to suppress the oxidation is difficult to use in terms of optical design.

Generally, to reduce the reflectivity of a facet of a semiconductor laser, a so-called “window structure” in which a layer structure that forms a waveguide is removed near the facet and a transparent region is formed in the removed portion is used. In the window structure, because a waveguide structure in the vertical direction is missing near the facet, the field distribution of light guided is not maintained near the facet. In the window structure, if the semiconductor material formed after the removal of the layer structure is of a material not containing aluminum (Al), the effect of suppressing the oxidation of the facet of an AlGaInAs active layer can be obtained. Furthermore, in a buried waveguide structure, it is easy to form a window structure by carrying out the burying of the sides of the waveguide and the forming of the window structure of the facet at the same time. However, in the procedure to form a window structure in a ridge waveguide structure, the removal of the layer structure and forming of the ridge cannot be performed at the same time. Because the field distribution of light in the vertical direction is not maintained near the facet, it becomes necessary not to form the ridge at the position where the layer structure is removed for not causing an astigmatic difference. However, these two processes cannot be performed at the same time, and thus their positioning accuracy becomes a problem in manufacturing. Accordingly, forming a window structure is difficult particularly in a ridge waveguide structure suitable for an AlGaInAs active layer, and the inhibition of the oxidation of the facet by this method is difficult.

On the contrary, according to the embodiments that will be explained below, the oxidation of the active layer can be suppressed and the degradation of device characteristics can be prevented, whereby a highly reliable and long-life semiconductor optical device can be provided.

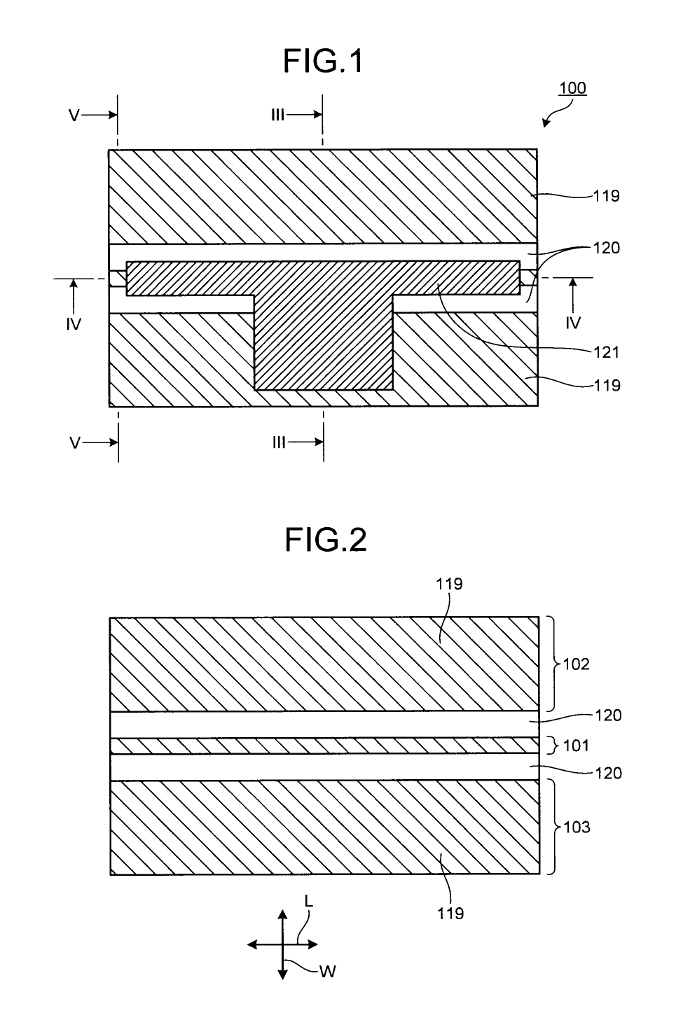

FIGS. 1 to 13 illustrate a semiconductor laser 100 as a semiconductor optical device according to a first embodiment of the present invention. FIG. 1 is a plan view of the semiconductor laser according to the first embodiment, and FIG. 2 is a plan view of the semiconductor laser without an electrode.

The semiconductor laser 100 according to the first embodiment has a ridge waveguide structure. As shown in FIG. 2, in the semiconductor laser 100, a ridge waveguide 101 is formed in a straight stripe mesa, and supporting mesas 102 and 103 for protecting the ridge waveguide 101 are formed on both sides thereof at a distance in the width direction W.

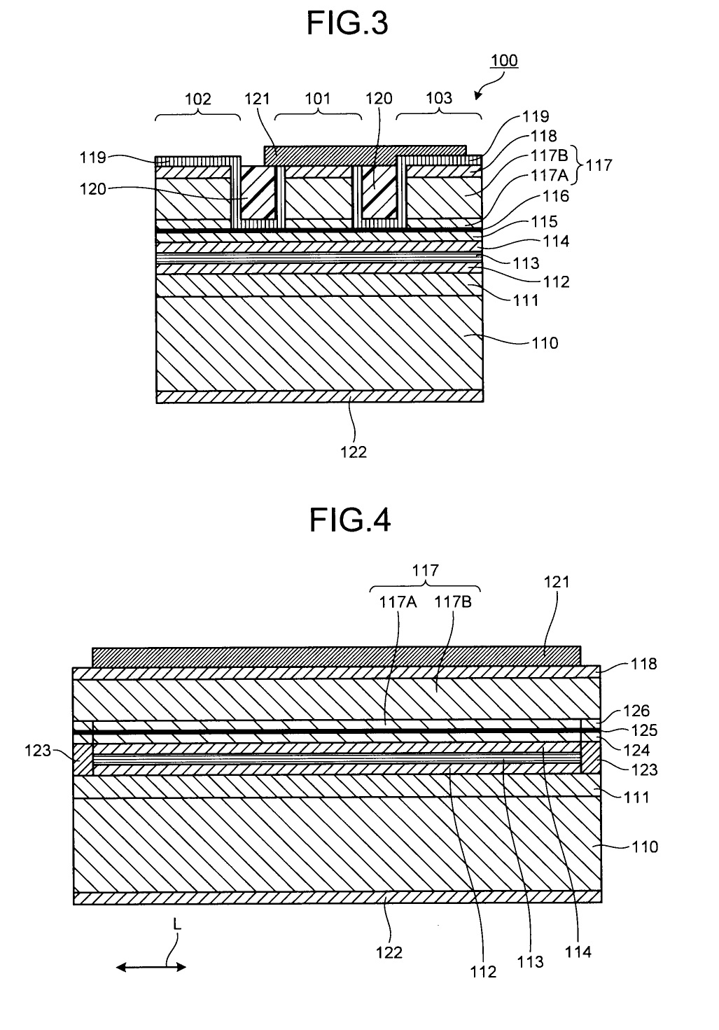

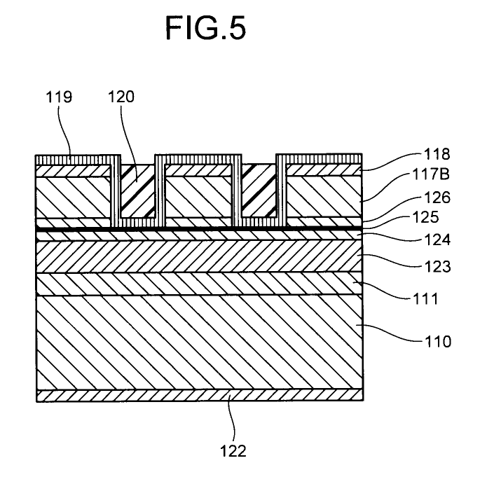

FIG. 3 is a cross-sectional view taken along a line III-III shown in FIG. 1, FIG. 4 is a cross-sectional view taken along a line IV-IV shown in FIG. 1 that is in parallel with the length direction L, and FIG. 5 is a cross-sectional view taken along a line V-V shown in FIG. 1. As shown in FIG. 3, the layer structure of the semiconductor laser 100 includes the layers grown on an n-InP substrate 110 in the order of an n-InP buffer layer 111 as a lower cladding layer, a lower separate confinement heterostructure (SCH) layer 112 of AlGaInAs, a multiple quantum well (MQW) active layer 113 of AlGaInAs having a gain band at a wavelength of 1.55 micrometers, an upper SCH layer 114 of AlGaInAs, a spacer layer 115 of p-InP that is a part of an upper cladding layer, an etch stop layer 116 of GaInAsP, and a cladding layer 117 of p-InP and a contact layer 118 of p-GaInAs to be formed in a mesa.

As shown in FIG. 3, in the semiconductor laser 100, on the mesa-formed layer structure, an insulating film 119 that blocks current flowing into areas other than the ridge waveguide, a planarizing polymer 120, and a p-side electrode 121 of Ti/Pt/Au are formed. On the rear surface of the semiconductor laser 100, an n-side electrode 122 of AuGeNi is formed.

As shown in FIGS. 4 and 5, at both facets of the semiconductor laser 100 in the length direction L, in place of the lower SCH layer 112, the MQW active layer 113, and the upper SCH layer 114 in the portion located at the center in the length direction L, a core layer 123 as a passive waveguide layer of GaInAsP not containing Al is formed. When the gain of the MQW active layer 113 is at a 1.55-micrometer wavelength band, the composition of the core layer 123 is selected to be a composition that renders, for example, a bandgap wavelength of 1.3 micrometers so that it is transparent to the light of a 1.55 micrometer wavelength. Furthermore, to avoid loss at a connecting portion, it is preferable that the thickness of the core layer 123 be designed such that the field distribution of the light guided through the active layer and the field distribution of the light guided through the passive waveguide layer are substantially the same.

The length of the core layer 123 near the facet of the semiconductor laser 100 in the length direction L only needs to be sufficiently long with respect to the positional accuracy of cleaving, and a few tens of micrometers are enough. When the length of the core layer 123 near the facet is too long, the length of the device increases and the number of devices obtained from a single wafer decreases. Therefore, it is preferable that the length of the portion of the core layer 123 be designed to be a value as small as possible in a range larger than the positional accuracy of cleaving, more specifically, less than 100 micrometers.

Next, a method of manufacturing the semiconductor laser 100 according to the first embodiment will be explained.

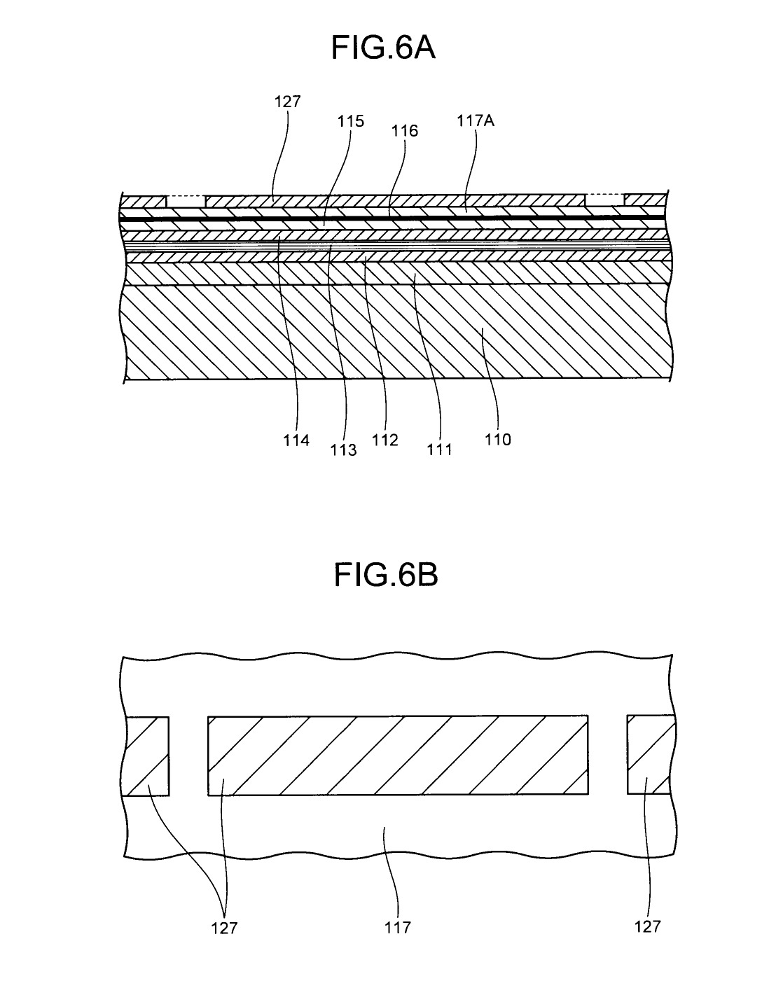

As shown in FIG. 6A, on the n-InP substrate 110, by metal organic chemical deposition (MOCVD) method or the like, the layers of the n-InP buffer layer 111 of the lower cladding layer, the lower SCH layer 112 of AlGaInAs, the MQW active layer 113 of AlGaInAs, the upper SCH layer 114 of AlGaInAs, the spacer layer 115 of p-InP that is a part of the upper cladding layer, the etch stop layer 116 of p-GaInAsP, and a cladding layer 117A constituting a part of the cladding layer 117 of p-InP are grown in this order. Then, after depositing a silicon nitride (SiNₓ) film 127 on the entire surface, patterning is performed by photolithography so that a pattern of stripes wider than the ridge waveguide is formed, excluding vicinities of the facets, as indicated in FIGS. 6A (cross-sectional pattern) and 6B (plane pattern).

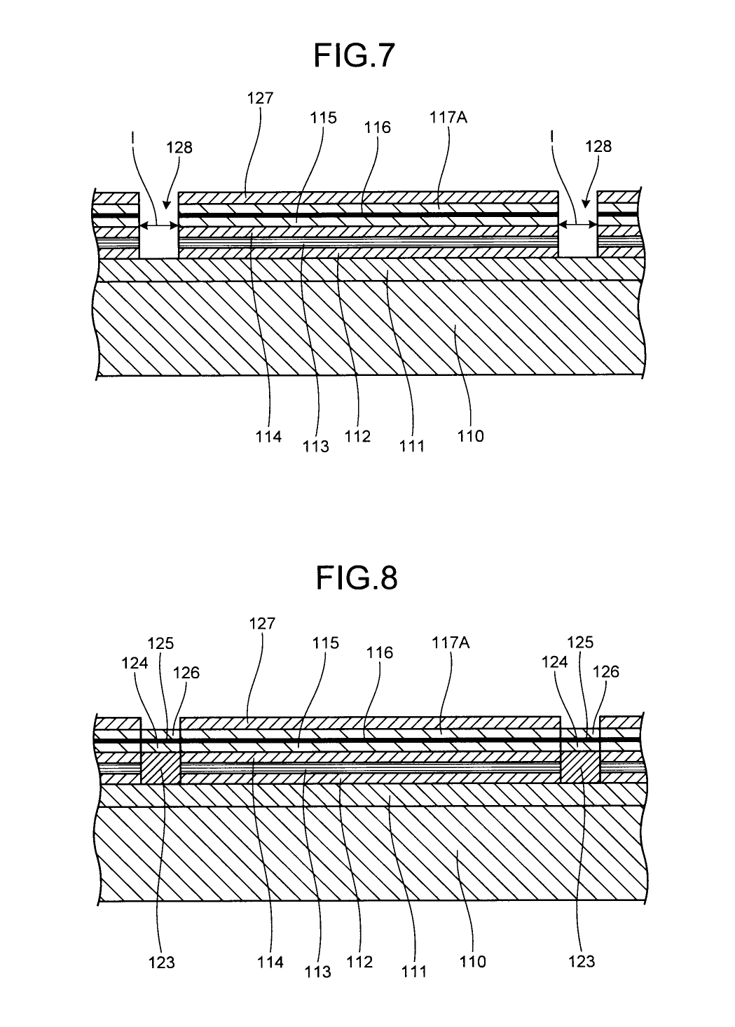

As shown in FIG. 7, etching is performed using the patterned SiNx film 127 as an etching mask to remove the cladding layer 117A of p-InP, the etch stop layer 116, the spacer layer 115, and the layer structure down to the lower SCH layer 112 as an active layer (passive waveguide layer), and to expose the n-InP buffer layer 111. As shown in FIG. 7, the length 1 of each recess 128 formed by the etching and lined along the length direction L between adjacent portions of the SiNx film 127 is set to equal to or longer than 20 micrometers and equal to or shorter than 200 micrometers.

Then, in the recess 128, burying of the core layer is performed. More specifically, as shown in FIG. 8, using the mask of the SiNx film 127 as it is as a mask for selective growth, a core layer 123 of i-InGaAsP, an i-InP layer 124, an etch stop layer 125 of i-GaInAsP, and an i-InP layer 126 are grown by MOCVD method to make a butt-joint. While the i-InP layer 124, the etch stop layer 125, and the i-InP layer 126 may be doped layers having p-type conductivity, it is preferable to be of non-doped in terms of reducing loss by inter-valence band absorption.

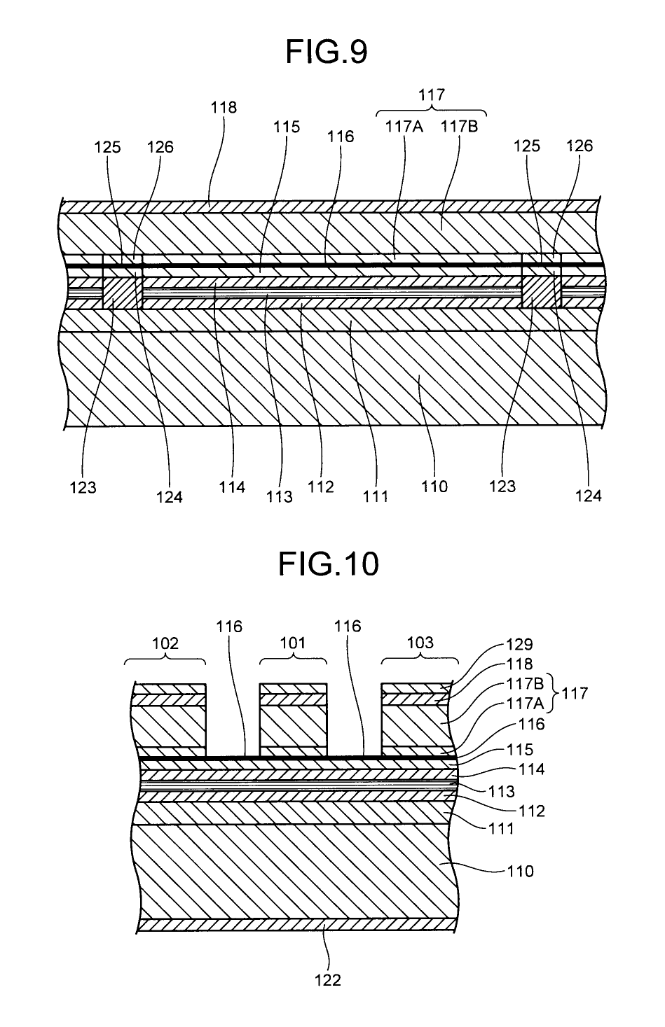

As shown in FIG. 9, the mask of the SiNx film 127 is removed, and on the entire surface of the cladding layer 117A of p-InP, the layers of a cladding layer 117B of p-InP that is a remaining portion of the cladding layer 117 and the contact layer 118 of p-GaInAsP are grown in this order.

Then, after depositing a SiNx film 129 over the entire surface of the contact layer 118 of p-GaInAsP, patterning is performed using photolithography technology. As shown in FIG. 10, using the patterned SiNx film 129 as an etching mask, etching of the portions corresponding to areas between the ridge waveguide 101 and the supporting mesas 102 and 103 is performed using a known etching method. In this case, the etching is performed until it reaches down to the etch stop layer 116 of GaInAsP.

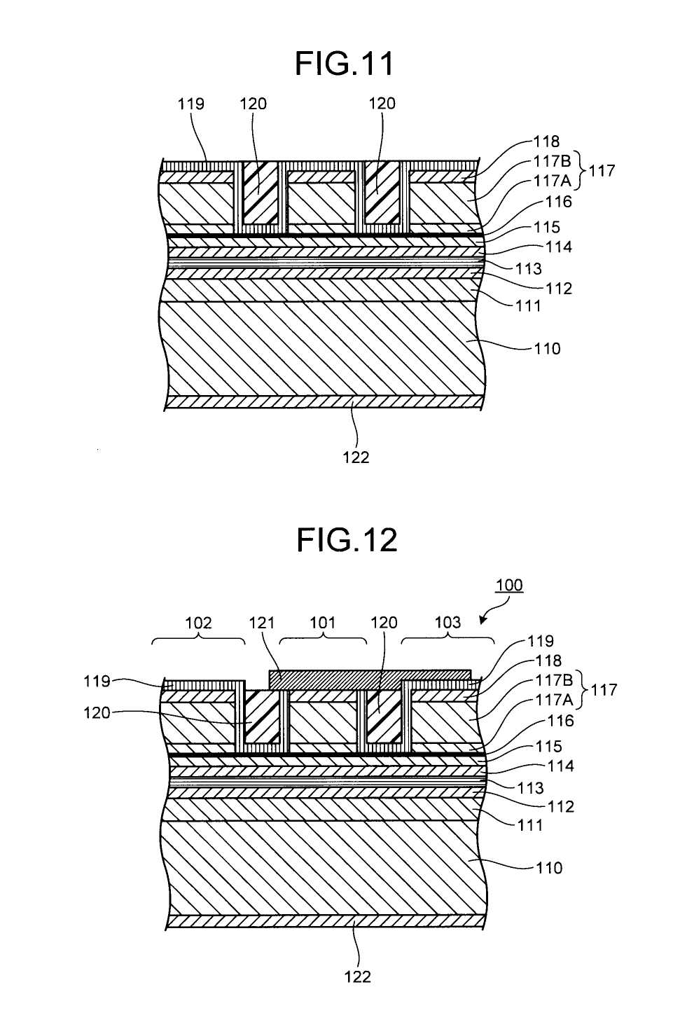

Under the condition that the SiNx film 129 is removed or is not removed, as shown in FIG. 11, after depositing the insulating film 119 of a SiNx film on the entire surface, the planarizing polymer 120 is spin-coated. The planarizing polymer 120 is then patterned by photolithography to leave it in only the portions corresponding to areas between the ridge waveguide 101 and the supporting mesas 102 and 103. Then, after curing the planarizing polymer 120, only the portion of the insulating film 119 where an electrode is to be formed is removed. Thereafter, as shown in FIG. 12, the p-side electrode 121 of Ti/Pt/Au is formed. Furthermore, after lapping and polishing the n-InP substrate 110 to a desired thickness, the n-side electrode 122 of AuGeNi is formed on the entire surface of the rear surface.

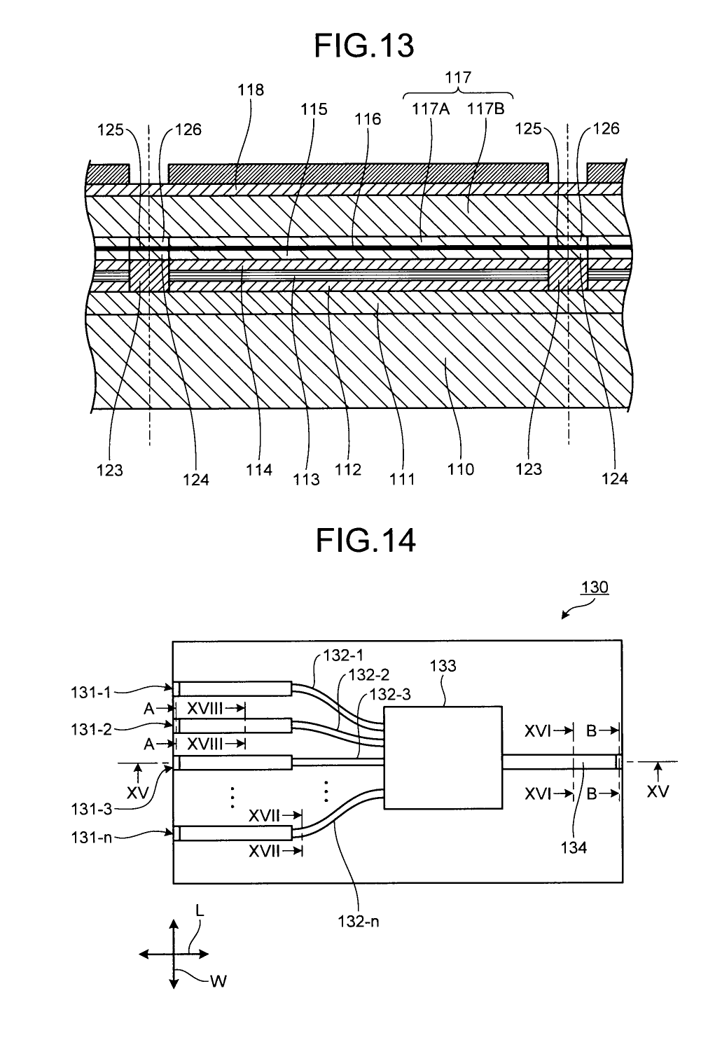

Lastly, as shown in FIG. 13, the n-InP substrate 110 is cleaved at the positions indicated by a dashed-dotted lines in FIG. 13 (portions where the core layer 123 of GaInAs is provided) so that a plurality of semiconductor lasers 100 are lined in the width direction W (see FIG. 2) in a bar shape, and a coating to obtain a desired reflectivity is applied on both facets. Thereafter, separating the semiconductor lasers 100 lined in a bar shape into the individual semiconductor lasers 100 completes the semiconductor laser 100.

In the semiconductor laser 100 according to the first embodiment, the oxidation of AlGaInAs is not caused because the AlGaInAs is not exposed at the facets. Therefore, in the present embodiment, by preventing the device characteristics from degrading, a highly reliable and long-life semiconductor optical device can be obtained.

Comparing the semiconductor laser 100 according to the first embodiment with a semiconductor laser having a window structure simply formed with InP without forming the core layer 123 of i-InGaAsP near the facet at the time of growth making a butt-joint, the semiconductor laser 100 according to the first embodiment has an advantage in that an extra optical loss is unlikely to occur because there is no variations in the field distribution of light near the facet due to the semiconductor laser 100 being of the waveguide structure in the growth direction. Furthermore, it is advantageous in terms of astigmatic difference being not caused because the portion of the ridge waveguide where the core layer 123 is provided has the waveguide structure in the growth direction.

Next, an integrated semiconductor laser device as a semiconductor optical device according to a second embodiment of the present invention will be described. FIG. 14 is a plan view of an integrated semiconductor laser device 130 according to the second embodiment.

As shown in FIG. 14, the integrated semiconductor laser device 130 according to the first embodiment has a structure integrating a plurality of distributed feedback (DFB) laser stripes 131-1 to 131-n (n is an integer equal to or larger than two), a plurality of optical waveguides 132-1 to 132-n, a multimode interference (MMI) coupler 133, and a semiconductor optical amplifier 134 on a single semiconductor substrate.

The laser stripes 131-1 to 131-n are of edge-emitting lasers each having a ridge waveguide structure in a stripe shape with a width of 2 micrometers and a length of 600 micrometers, and are formed at one end of the integrated semiconductor laser device 130, for example, with a 25-micrometer pitch in the width direction W. The laser stripes 131-1 to 131-n are configured such that the wavelengths of light output differ in a range of 1530 nanometers to 1570 nanometers by differing from one another the interval of diffraction grating provided to each of the laser stripes. Furthermore, the laser emission wavelengths of the laser stripes 131-1 to 131-n can be adjusted by varying the setting temperature of the integrated semiconductor laser device 130. In other words, the integrated semiconductor laser device 130 realizes a wide range of tunable wavelengths by switching the laser stripes 131-1 to 131-n to drive and controlling the temperature.

The MMI coupler 133 is formed near the center portion of the integrated semiconductor laser device 130. The optical waveguides 132-1 to 132-n are formed between the laser stripes 131-1 to 131-n and the MMI coupler 133 and optically connect the respective laser stripes 131-1 to 131-n with the MMI coupler 133. The semiconductor optical amplifier 134 is formed on one end side of the integrated semiconductor laser device 130 opposite to the laser stripes 131-1 to 131-n.

Next, the operation of the integrated semiconductor laser device 130 will be described. First, a laser stripe selected from the laser stripes 131-1 to 131-n is driven. Out of the optical waveguides 132-1 to 132-n, corresponding one of the optical waveguides 132-1 to 132-n optically connected with one of the laser stripes 131-1 to 131-n driven guides the light output from the driven laser stripe. The MMI coupler 133 passes the light guided through the optical waveguides 132-1 to 132-n and outputs it from an output port. The semiconductor optical amplifier 134 amplifies the light output from the MMI coupler 133 and outputs it from an output terminal. The semiconductor optical amplifier 134 is used to compensate the loss of light at the MMI coupler 133 in the light output from the laser stripes 131-1 to 131-n driven and to obtain an optical power of a desired intensity from the output terminal.

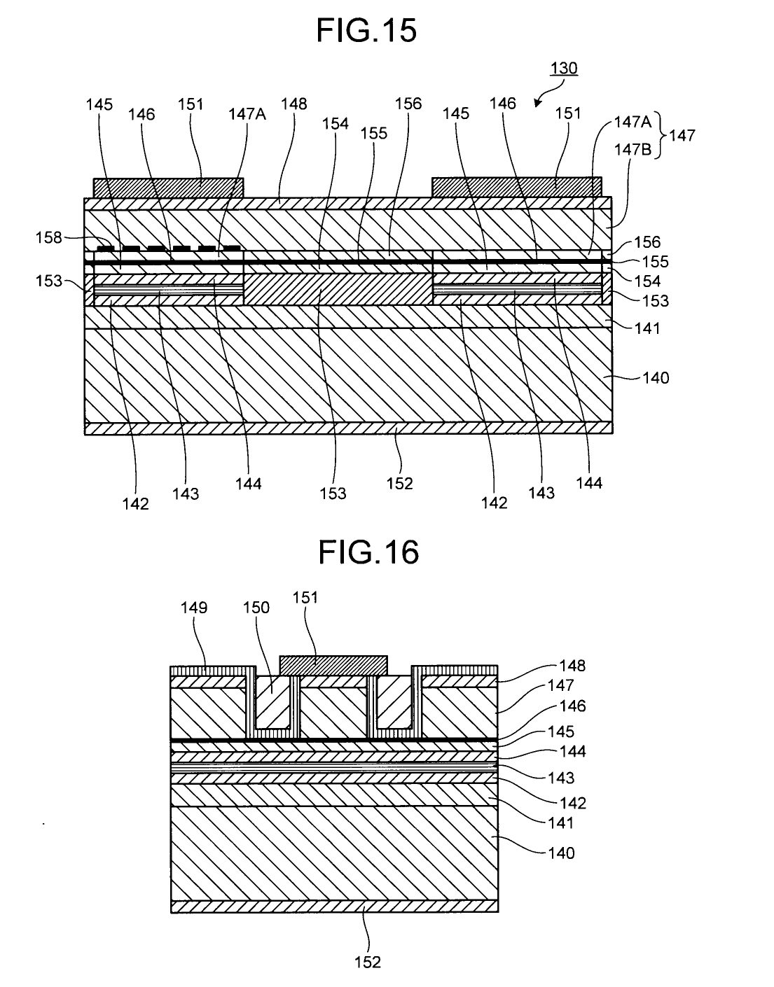

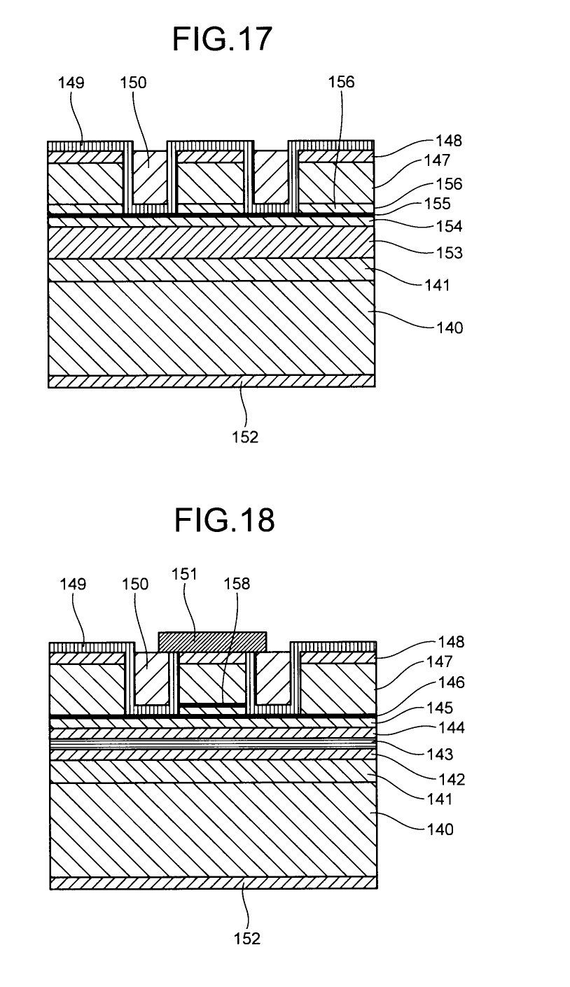

FIG. 15 is a cross-sectional view taken along a line XV-XV shown in FIG. 14, FIG. 16 is a cross-sectional view taken along a line XVI-XVI shown in FIG. 14, FIG. 17 is a cross-sectional view taken along a line XVII-XVII shown in FIG. 14, and FIG. 18 is a cross-sectional view taken along a line XVIII-XVIII shown in FIG. 14. A cross-sectional view taken along a line A-A and a cross-sectional view taken along a line B-B shown in FIG. 14 are substantially the same as a cross-sectional view shown in FIG. 17.

As shown in FIG. 16, the semiconductor layer structure includes the layers formed on an n-InP substrate 140 in the order of a buffer layer 141 of n-InP as a lower cladding layer, a lower SCH layer 142 of AlGaInAs, an MQW active layer 143 of AlGaInAs having a gain band at a wavelength of 1.55 micrometers, an upper SCH layer 144 of AlGaInAs, a spacer layer 145 that is a part of an upper cladding layer and is made of p-InP, an etch stop layer 146 of GaInAsP, and a cladding layer 147 of p-InP and a contact layer 148 of p-GaInAs to be formed in a mesa.

In the integrated semiconductor laser device 130, as shown in FIG. 16, on the mesa-formed layer structure, an insulating film 149 that blocks current flowing into areas other than the ridge waveguide, a planarizing polymer 150, and a p-side electrode 151 of Ti/Pt/Au are formed. On the rear surface thereof, an n-side electrode 152 of AuGeNi is formed.

In the optical waveguides 132-1 to 132-n, in place of the lower SCH layer 142 of AlGaInAs, the MQW active layer 143 of AlGaInAs, and the upper SCH layer 144 of AlGaInAs, a core layer 153 as a passive waveguide layer of GaInAsP without containing Al is formed (see FIG. 17). When the gain of the MQW active layer 143 is at a 1.55-micrometer wavelength band, the composition of the core layer 153 of GaInAsP is selected to be a composition that renders, for example, a bandgap wavelength of 1.3 micrometers so that it is transparent to the light of a 1.55 micrometer wavelength. The length of the core 153 of GaInAsP near the facet only needs to be a few hundreds of nanometers in terms of oxidation prevention. While it is determined corresponding to the manufacturing accuracy in design, it only needs to be sufficiently long with respect to the positional accuracy of cleaving that is large in error in processes and less than 100 micrometers is enough.

As shown in FIG. 18, in the cladding layer 147 of p-InP constituting the ridge waveguide in the cross-section shown in FIG. 16, a grating layer 158 is included.

Next, a method of manufacturing the integrated semiconductor laser device 130 according to the second embodiment will be explained.

On the n-InP substrate 140, the layers are grown by MOCVD method or the like in the order of the buffer layer 141 of n-InP as the lower cladding layer , the lower SCH layer 142 of AlGaInAs, the MQW active layer 143 of AlGaInAs, the upper SCH layer 144 of AlGaInAs, the spacer layer 145 of p-InP that is a part of the upper cladding layer, the etch stop layer 146 of p-GaInAsP, a part of the cladding layer 147 (indicated by “147A” in Fig.) of p-InP including the grating layer 158 of GaInAsP.

After depositing a SiNx film on the entire surface, patterning is performed so that the patterns of diffraction gratings different in pitch from one another are formed at the positions where the respective laser stripes 131-1 to 131-n are formed. Etching is then performed with the SiNx film as a mask to form the diffraction gratings in the grating layer 158 of GaInAsP and to entirely remove the grating layer 158 of GaInAsP in other areas.

After the mask of the SiNx film is removed, the cladding layer 147A of p-InP is grown again.

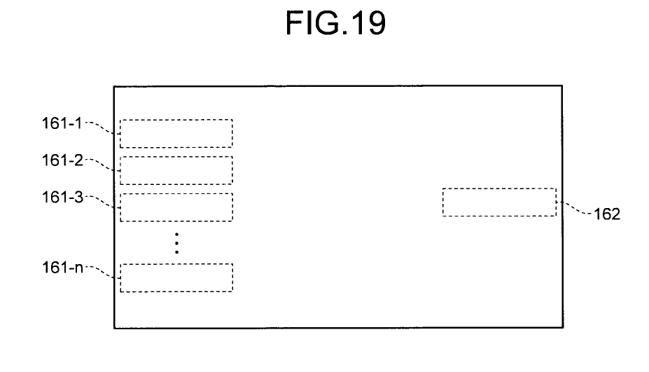

Thereafter, after depositing a SiNx film on the entire surface, as shown in FIG. 19, patterning is performed so that patterns 161-1 to 161-n and 162 of stripes wider than the ridge waveguides of the laser stripes 131-1 to 131-n and the semiconductor optical amplifier 134 and excluding vicinities of the facets are formed by photolithography technology. Etching is performed using the patterned SiNx film as an etching mask to remove a part of the p-InP cladding layer 147 down to the lower SCH layer 142 of AlGaInAs.

With the mask of the SiNx film as it is as a mask for selective growth, the core layer 153 of i-InGaAsP, an i-InP layer 154, an etch stop layer 155 of i-InGaAsP, and an i-InP layer 156 are grown by MOCVD method to make a butt-joint. While the i-InP layer 154, the etch stop layer 155 of i-GaInAsP, and the i-InP layer 156 may be p-doped to have p-type conductivity, it is preferable to be non-doped in terms of reducing loss by inter-valence band absorption.

The mask of the SiNx film is then removed, and on the entire surface, the layers of a remaining portion 147B of the cladding layer 147 of p-InP and the contact layer 148 of p-GaInAs are grown in this order.

Then, after depositing a SiNx film on the entire surface, patterning is performed by photolithography technology. Using the patterned SiNx film as an etching mask, etching of the portions corresponding to areas between the laser stripes 131-1 to 131-n, the optical waveguides 132-1 to 132-n, the MMI coupler 133, and the semiconductor optical amplifier 134 and their supporting mesas (not shown) is performed using a known etching method. In this case, the etching is performed until it reaches down to the etch stop layer 146 of GaInAsP.

After depositing the insulating film 149 of a SiNx film on the entire surface, the planarizing polymer 150 is spin-coated and then patterned by photolithography technology to leave it in only the portions corresponding between the laser stripes 131-1 to 131-n, the optical waveguides 132-1 to 132-n, the MMI coupler 133, and the semiconductor optical amplifier 134 and their supporting mesas (not shown). Then, after curing the planarizing polymer 150, only the portions of the insulating film 149 where electrodes are to be formed are removed. Thereafter, the p-side electrodes 151 of Ti/Pt/Au are formed. Furthermore, after lapping and polishing the n-InP substrate 140 to a desired thickness, the n-side electrode 152 of AuGeNi is formed on the entire rear surface.

Lastly, the n-InP substrate 140 is cleaved so that a plurality of integrated semiconductor laser devices 130 are lined in a bar shape, and a low-reflectivity coating is applied on both facets. Thereafter, separating the integrated semiconductor laser devices 130 individually completes the integrated semiconductor laser device 130.

The integrated semiconductor laser device 130 according to the second embodiment provides an advantage in that the oxidation of AlGaInAs is not caused because no AlGaInAs is exposed at the facets. Furthermore, in the integrated semiconductor laser device 130 including functional portions by passive waveguides as in the second embodiment, the fact that there is no increase in the number of processes by forming the passive waveguides near the facets makes it particularly suitable as an embodiment of the present invention.

While the exemplary embodiments of the present invention have been explained in the foregoing, the description and the drawings constituting a part of the disclosure of the first and second embodiments are not intended to limit the invention. The disclosure will make various alternative embodiments, examples, and operation technologies obvious to a person of ordinary skill in the art.

For example, in the first and second embodiments, while GaInAsP is used as the material for the waveguide layer near the facet, other materials that can form the waveguides without containing aluminum may be applied. Furthermore, the waveguide layer near the facet can be an active layer of a material without containing aluminum. Moreover, as a material unsusceptible to oxidation for the waveguide layer near the facet, AlGaInAs of a sufficiently low aluminum composition can be used.

In the first and second embodiments, while the invention has been explained being applied to the semiconductor laser 100 and the integrated semiconductor laser device 130 having the integrated semiconductor optical device structure, the invention can be applied to other semiconductor optical devices the core layer of which has a structure with a first core layer of a material susceptible to oxidation and a second layer of a material unsusceptible to oxidation being connected in sequence in the optical propagation direction. It is preferable that the second core layer be made of a material at least less susceptible to oxidation than the first core layer.

As described above, the semiconductor optical device according to the present invention is suitable to be applied in the fields of optical communications and the like.

Although the invention has been described with respect to specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A semiconductor optical device including at least a lower cladding layer formed on a semiconductor substrate, a core layer formed on the lower cladding layer, and an upper cladding layer formed on the core layer, wherein
the core layer includes
a first core layer of a material susceptible to oxidation, and
a second core layer of a material unsusceptible to oxidation, the first core layer and the second core layer being connected in sequence in an optical propagation direction, and
the second core layer is formed at a facet where a light is input or output.

2. The semiconductor optical device according to claim 1, wherein
the first core layer is made of a first material containing aluminum, and
the second core layer is made of a second material without containing aluminum.

3. The semiconductor optical device according to claim 1, wherein
the first core layer is an active layer, and
the second core layer is a passive waveguide layer.

4. The semiconductor optical device according to claim 2, wherein
the first core layer is an active layer, and
the second core layer is a passive waveguide layer.

5. The semiconductor optical device according to claim 1, wherein a field distribution of a light propagating the first core layer and a field distribution of a light propagating the second core layer are substantially same.

6. The semiconductor optical device according to claim 2, wherein each of the lower cladding layer and the upper cladding layer is made of the second material.

7. The semiconductor optical device according to claim 1, wherein at least a part of the upper cladding layer is formed in a mesa.

8. The semiconductor optical device according to claim 5, wherein at least a part of the upper cladding layer is formed in a mesa.

9. The semiconductor optical device according to claim 2, wherein
the first material is AlGaInAs, and
the second material is GaInAsP.

10. The semiconductor optical device according to claim 6, wherein
the first material is AlGaInAs, and
the second material is GaInAsP.

11. The semiconductor optical device according to claim 9, wherein the semiconductor substrate is made of InP.

12. The semiconductor optical device according to claim 1, wherein a length of the second core layer at the facet where light is input or output is less than 100 micrometers.

13. The semiconductor optical device according to claim 3, wherein the semiconductor optical device has an integrated semiconductor optical device structure including a functional portion by the passive waveguide.

14. The semiconductor optical device according to claim 4, wherein the semiconductor optical device has an integrated semiconductor optical device structure including a functional portion by the passive waveguide.
